(19) United States
(12) Patent Application Publication
(10) Pub. No.: US 2005/0274072 A1
(43) Pub. Date: Dec. 15, 2005

(54) Method of Preserving a Live Tree

(76) Inventor: Ming-Shean Ueng, Hollywood, FL (US)

Correspondence Address: PATWRITE, 413 E 13TH ST, AMES, IA, 50010, US

(21) Appl. No.: 11/161,161

(22) Filed: Aug. 12, 2005

Related U.S. Application Data
(63) Continuation-in-part of application No. 10/244,206, filed on Sep. 16, 2002.

(51) Int. Cl. A01G 7/00

(52) U.S. Cl. 47/58.1 R

(57) ABSTRACT

The present invention provides a method of preserving a live tree for repeated indoor and outdoor use such as during a holiday season where the tree can be decorated and then moved back outside to continue growing for use next year. A root portion of the live tree is prepared and bent according to the present method to provide a support structure for the tree while maintaining the root function of the tree for continued health. The tree can be placed in a container that facilitates transfer back and forth between the outside environment and interior use during holiday seasons. The present invention provides the esthetic of having a live tree during holiday seasons, yet eliminates the waste and clean up associated with simply cutting down a tree and bringing inside and then disposing of the dead tree.

### CROSS-REFERENCE TO RELATED APPLICATIONS

This application is a continuation in part of U.S. patent application Ser. No. 10/244,206, filed Sep. 16, 2002, now abandoned.

### BACKGROUND OF THE INVENTION

Each year, millions of people buy a tree for Christmas and each year the trees die and must be thrown out. The custom of cutting live trees down and bringing them inside the home is an ancient tradition. In modern life, time is often at a premium and in an effort to accommodate many different lifestyles, some people resort to artificial trees. With an artificial tree, one can start decorating early without the tree dying before the holiday begins. Many people, however, want a live tree with the accompanying tree “scent” and feeling associated with a live tree.

Additionally, people have had to choose between having an artificial tree or purchasing a new tree every year. Once the tree is cut, the tree starts to die and one has to deal with falling needles. This makes clean-up more difficult and time consuming along with contributing to the solid waste disposal problem.

There is a need for a method of using a live tree during the holiday season, while keeping the tree alive and able to be moved back outside to grow until the next holiday season.

### SUMMARY OF THE INVENTION

The present invention is a method of preserving a live tree for repeated use year after year that maintains the trees viability, yet easily allows the tree to be moved inside and back outside. The tree can be moved inside at any time and can be decorated without killing the tree and clean-up is greatly reduced since the live tree will not lose many needles. The present invention reduces waste and tree removal problems associated with cut trees. Other features and advantages of the instant invention will become apparent from the following description of the invention which refers to the accompanying drawings.

### BRIEF DESCRIPTION OF THE DRAWINGS

FIG. 1 shows a front view of live tree with an intact root system.

FIG. 2 is a sectional view of an upper bend section according to the present invention.

FIG. 3 is a sectional view of a lower bend section according to the present invention.

FIG. 4 is a front view of a root section according to the present invention.

FIG. 5 is a front view of an embodiment of the invention.

### DETAILED DECRIPTION OF THE INVENTION

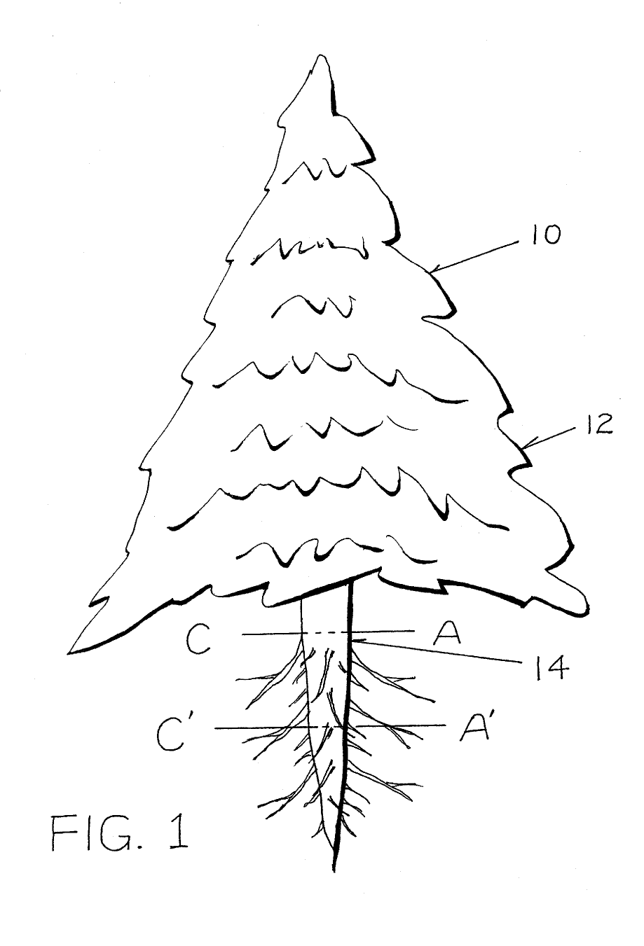

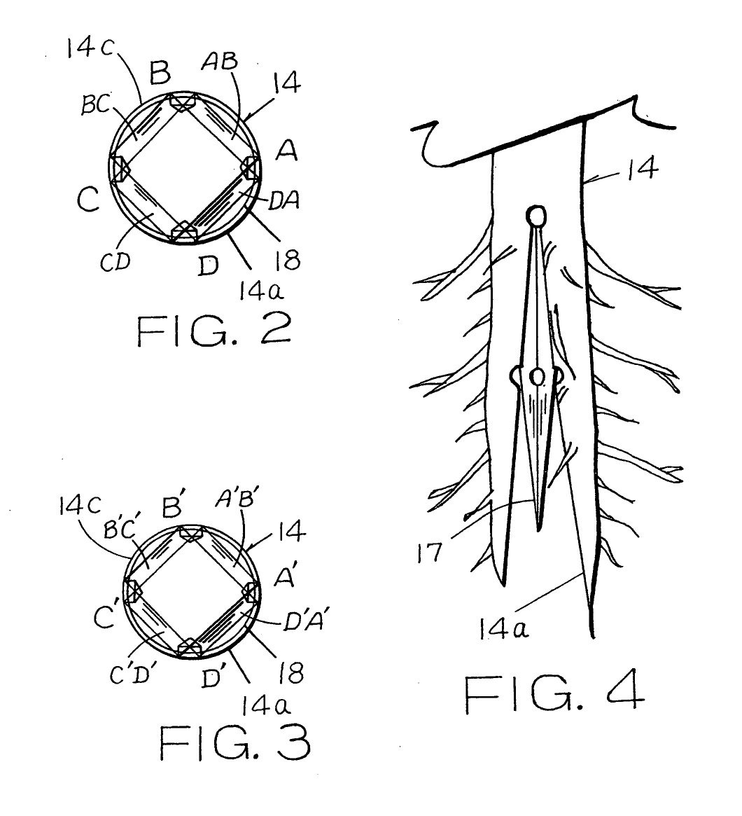

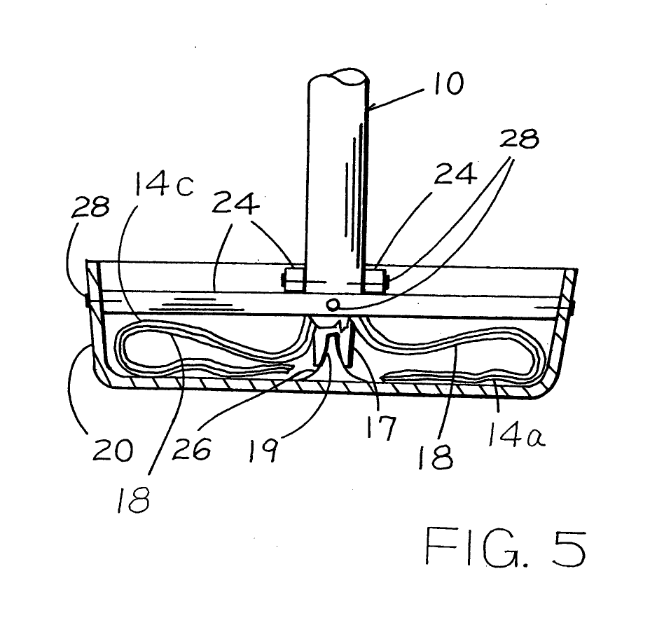

Referring to FIGS. 1 through 5, a Christmas tree 10 has a leaf section 12 and a root section 14. Root section 14 is shown with two bending sections; an upper bending section AC and a lower bending section A′ C′.

With reference to FIGS. 1, 2, 3 and 4, upper bending section AC is shown having four upper entry holes A, B, C and D drilled perpendicularly to root section 14 and only penetrate root section 14 a small distance. Next upper channel holes AB, BC, CD and DA are drilled connecting upper entry holes A, B, C, and D. This process is repeated on lower bending section A′ C′. A saw is inserted through upper channel hole DA and root section 14 is cut all the way down passing through channel hole D′A′ and then passing completely through root section 14. The process is repeated with each of the remaining upper channel holes BC, CD and AB.

Referring now to FIGS. 1 through 5, root section 14 has been prepared having four split root sections (only 14a and 14c are shown) as discussed above. For simplicity, detailed reference is made only with respect to one split root section 14a, but the process is identical for each of the other split root sections. Split root section 14a has an inner root core side 18.

Tree 10 prepared according to the present invention will now have four split root sections (only 14a and 14c are shown). Again, reference is only made with respect to split root section 14a, but the process is repeated with each of the remaining split root sections. Root center core 17 is cut off several inches below upper bending section AC. A support hole 19 is drilled at the bottom of newly cut root center core 17 providing support when tree 10 is placed on a support 26 located in the base of a container 20. A protective coating is brushed or sprayed on inner root core side 18 of split root section 14a and allowed to dry. It is important that only the inner root core side 18 be coated leaving all outer skin surfaces untouched. The process is repeated on the remaining split root sections cores (not shown). Root center core 17 is also covered with a protective coating.

Split root section 14a is now bent horizontally along upper bending section AC and then bent back along itself at lower bending section A‘C’ providing a flattened portion that is roughly perpendicular to root center core 17. The folded split root section 14a is tied or taped together to retain the flattened shape. The process is repeated with the remaining split root sections. Tree 10 is then placed in container 20 with support 26 fitting into support hole 19 that was drilled into the bottom center of root center core 17. Wood blocks 24 are arranged to help support tree 10 and attached to tree 10 with fasteners 28. Blocks 24 are placed above upper bending section AC and soil (not shown) is added. Tree 10 is now ready to be moved. Tree 10 prepared according to the present invention should be placed in a shady area to encourage growth.

The container 20 may have a plurality of holes in its bottom surface (not shown) in order to allow split root sections to “breathe” by being able to make contact to the soil when the tree 10 is located outdoors. When moving the tree 10 to an indoor location, it is desirable to wrap the container in a suitable cloth or other container to minimize dirt transfer.

In another embodiment of the present invention, a wooden cross fixture (not shown) is utilized instead of the container 20. The bent split root sections are attached to the wooden cross fixture and wrapped with a suitable cloth and filled with soil or other growing medium. In this way, the tree 10 prepared according to the present invention would be portable and yet remain alive for use year after year.

In another embodiment of the present invention, split root section 14a is cut off to save time by not having to dig a deep hole in the case where people living in smaller houses, apartments, etc. might not have room to utilize the above method for preserving a live tree for use year after year, but would still like to have a tree remain vibrant, green and living for an extended period of time. In this case, the tree 10 is prepared using upper bending section AC only. The split root section 14a will be cut off several inches below upper bending section AC therefore taking up very little space but greatly extending the life of the tree 10. Split root section 14a would not have a lower bending portion and would not have to be bent horizontally, therefore, saving space. In this embodiment, the longer the split root portion is, the longer the life of the tree 10 will be extended. The length of split root section 14a will depend on the space considerations of the user. Of course, each remaining split root section would be prepared in the same manner. A much smaller container 20 could be utilized with this embodiment. Because the root system of the tree 10 is compromised with this embodiment, the tree 10 would not be able to be used repeatedly year after year, but could provide a greatly extended lifespan for the seasonal tree.

Although the instant invention has been described in relation to particular embodiments thereof, many other variations and modifications and other uses will become apparent to those skilled in the art.

1. A method of preparing and preserving a live tree for repeated indoor and outdoor use comprising the steps of:
obtaining said live tree with an intact root system;
selecting a suitable root section of said live tree;
splitting said root section into a plurality of split root sections;
bending said plurality of root skins to form a generally horizontal base structure; and
covering said bent root skins with a suitable growing medium.

2. The method of preparing and preserving a live tree for repeated indoor and outdoor use according to claim 1 further comprising the step of coating an inner surface of said plurality of root skins with a preservative.

3. The method of preparing and preserving a live tree for repeated indoor and outdoor use according to claim 1 further comprising the step of cutting said root section several inches from said generally horizontal base structure.

4. The method of preparing and preserving a live tree for repeated indoor and outdoor use according to claim 1 further comprising the steps of:
drilling a plurality of upper entry holes perpendicularly and radially into an upper region of said selected root section;
drilling upper channel holes connecting two adjacent said plurality of upper entry holes;
drilling a plurality of lower entry holes wherein each of said upper entry hole is vertically aligned with each said lower entry hole;
drilling lower channel holes connecting two adjacent said plurality of lower entry holes wherein each of said upper and lower channel holes are vertically aligned with each other;
inserting a saw into each of said upper channel hole; and
cutting parallel to said root portion from each said upper channel hole towards each said lower channel hole wherein said plurality of split root sections of said root portion are formed.

5. The method of preparing and preserving a live tree for repeated indoor and outdoor use according to claim 1 wherein the step of bending said plurality of split root sections to form a generally horizontal base structure is performed by bending said plurality of split root sections generally ninety degrees from said root section and then bending said plurality of split root sections back on themselves generally one-hundred and eighty degrees.

6. The method of preparing and preserving a live tree for repeated indoor and outdoor use according to claim 3 further comprising the step of placing said tree in a container.

7. The method of preparing and preserving a live tree for repeated indoor and outdoor use according to claim 6 wherein said container has a centrally disposed post on a bottom portion therein.

8. The method of preparing and preserving a live tree for repeated indoor and outdoor use according to claim 7 further comprising the step of drilling a support hole centrally disposed in a bottom portion of said root section wherein when said tree is placed in said container, said support hole fits over said centrally disposed post on said bottom portion of said container providing support to said tree.

9. The method of preparing and preserving a live tree for repeated indoor and outdoor use according to claim 2 wherein said preservative is a lacquer base preservative.

10. The method of preparing and preserving a live tree for repeated indoor and outdoor use according to claim 1 wherein the step of bending said plurality of split root sections to form a generally horizontal base structure is performed by fixedly attaching said plurality of bent split root sections to a cross fixture to provide lateral stability.

11. The method of preparing and preserving a live tree for repeated indoor and outdoor use according to claim 10 wherein said cross fixture has at least one end stop distally located at an end of said cross fixture to support said root skin.

12. The method of preparing and preserving a live tree for repeated indoor and outdoor use according to claim 11 wherein said tree is fixedly attached to said cross fixture using a fastener centrally disposed on an intersecting portion of said cross support and penetrating exposed end of said root section.

13. The method of preparing and preserving a live tree for repeated indoor and outdoor use according to claim 1 wherein said step of covering said plurality of bent split root sections with a growing medium is performed by wrapping said plurality of bent split root sections with a cloth wrap enclosing said growing medium and secured by tying said cloth wrap at an upper portion therein.

14. The method of preparing and preserving a live tree for repeated indoor and outdoor use according to claim 1 wherein said growing medium is soil.

15. The method of preparing and preserving a live tree for repeated indoor and outdoor use according to claim 1 wherein said growing medium is a hydroponic growing medium.

16. A method of extending the life of a cut tree for indoor use comprising the steps of:
obtaining a fresh tree with an intact root system;
selecting a suitable root section of said tree;
splitting said root section into a plurality of split root sections;
cutting at least a portion of said root section off, thereby reducing the overall length of said root section;
bending said plurality of split root sections radially outward; and
covering said plurality of split root sections with a preserving medium.

17. The method of extending the life of a cut tree for indoor use according to claim 16 wherein said preserving medium is soil.

18. The method of extending the life of a cut tree for indoor use according to claim 16 wherein said preserving medium is water.

19. The method of extending the life of a cut tree for indoor use according to claim 16 wherein said preserving medium is a hydroponic growing medium.
